(19) United States
(12) Patent Application Publication
(10) Pub. No.: US 2014/0254128 A1
(43) Pub. Date: Sep. 11, 2014

(54) Solid State Lighting Device

(71) Applicant: Toshiba Lighting & Technology Corporation, Yokosuka-shi (JP)

(72) Inventors: Yoshihisa Ikeda, Yokosuka-shi (JP); Yoshihiro Kimura, Yokosuka-shi (JP)

(73) Assignee: TOSHIBA LIGHTING & TECHNOLOGY CORPORATION, Yokosuka-shi (JP)

(21) Appl. No.: 14/025,301

(22) Filed: Sep. 12, 2013

(30) Foreign Application Priority Data
Mar. 6, 2013 (JP) 2013-044736

(51) Int. Cl. F21K 99/00

(52) U.S. Cl. CPC F21K 9/56
USPC 362/84

(57) ABSTRACT

According to one embodiment, a solid state lighting device includes an irradiating section configured to emit laser light, a scattering section, and a wavelength conversion section. The scattering section has a principal plane provided to cross an optical axis of the laser light and includes a light scattering material that reflects the laser light made incident thereon and emits the laser light as scattered light. The wavelength conversion section absorbs the scattered light made incident from a first surface and emits wavelength-converted light having a wavelength larger than the wavelength of the laser light from a second surface on a side opposite to the first surface. The scattered light passes through the wavelength conversion section while being scattered and is emitted from the second surface.

### CROSS-REFERENCE TO RELATED APPLICATIONS

This application is based upon and claims the benefit of priority from Japanese Patent Application No. 2013-044736, filed on Mar. 6, 2013; the entire contents of which are incorporated herein by reference.

### FIELD

Embodiments described herein relate generally to a solid state lighting device.

### BACKGROUND

As a light source of a white solid state lighting (SSL) device using a solid state light-emitting element, an LED (Light Emitting Diode) is mainly used.

In that case, if a white light-emitting section including a phosphor is provided to cover an LED (Light Emitting Diode) chip, a substrate for thermal radiation and power supply for the LED chip is necessary. If the white light-emitting section includes only optical components, heat generation is small and the white light-emitting section is reduced in size and weight. Therefore, a degree of freedom of design of the solid state lighting device can be increased.

For that purpose, a structure only has to be adopted in which laser light from a semiconductor laser in a wavelength range of bluish purple to blue is efficiently coupled to an optical waveguide body or the like and irradiated on a wavelength conversion layer such as a phosphor separated from the solid state light-emitting element to obtain white emitted light.

In this case, in order to reduce the coherence of the laser light, a structure is conceivable in which, after the laser light is transmitted through a light scattering layer, scattered light is irradiated on the wavelength conversion layer. In this structure, the wavelength conversion layer is present on an optical axis of the laser light. Therefore, if damage to the light scattering layer and the wavelength conversion layer or the like occurs, a part of the laser light sometimes directly irradiates a lighting target. Therefore, there is room for further improvement in terms of safety.

A part of reflected light and wavelength-converted light by the light scattering layer and the wavelength conversion layer is emitted in a direction opposite to a lighting direction. Therefore, light extracting efficiency is reduced.

### BRIEF DESCRIPTION OF THE DRAWINGS

FIG. 1A is a schematic plan view of a solid state lighting device according to a first embodiment;

FIG. 1B is a schematic sectional view taken along line A-A in FIG. 1A;

FIG. 2 is a schematic sectional view of the solid state lighting device taken along line A-A in FIG. 1A;

FIG. 3A is a schematic plan view of a first modification of the first embodiment;

FIG. 3B is a schematic sectional view of a second modification of the first embodiment;

FIG. 4 is a schematic sectional view of a solid state lighting device according to a second embodiment;

FIG. 5 is a schematic sectional view of a solid state lighting device according to a third embodiment;

FIG. 6A is a schematic sectional view of a first modification of the third embodiment;

FIG. 6B is a schematic sectional view of a second modification of the third embodiment;

FIG. 7 is a schematic sectional view of a solid state lighting device according to a fourth embodiment;

FIG. 8 is a schematic sectional view of a solid state lighting device according to a fifth embodiment;

FIG. 9A is a schematic perspective view of a solid state lighting device according to a sixth embodiment; and

FIG. 9B is a schematic sectional view taken along line B-B in FIG. 9A.

### DETAILED DESCRIPTION

In general, according to one embodiment, there is provided a solid state lighting device including an irradiating section configured to emit laser light, a scattering section, and a wavelength conversion section. The scattering section has a principal plane provided to cross an optical axis of the laser light and includes a light scattering material that reflects the laser light made incident thereon and emits the laser light as scattered light. The wavelength conversion section absorbs the scattered light made incident through a first surface and emits wavelength-converted light having a wavelength longer than the wavelength of the laser light from a second surface on a side opposite to the first surface. The scattered light passes through the wavelength conversion section while being scattered and is emitted from the second surface.

Embodiments are explained below with reference to the drawings.

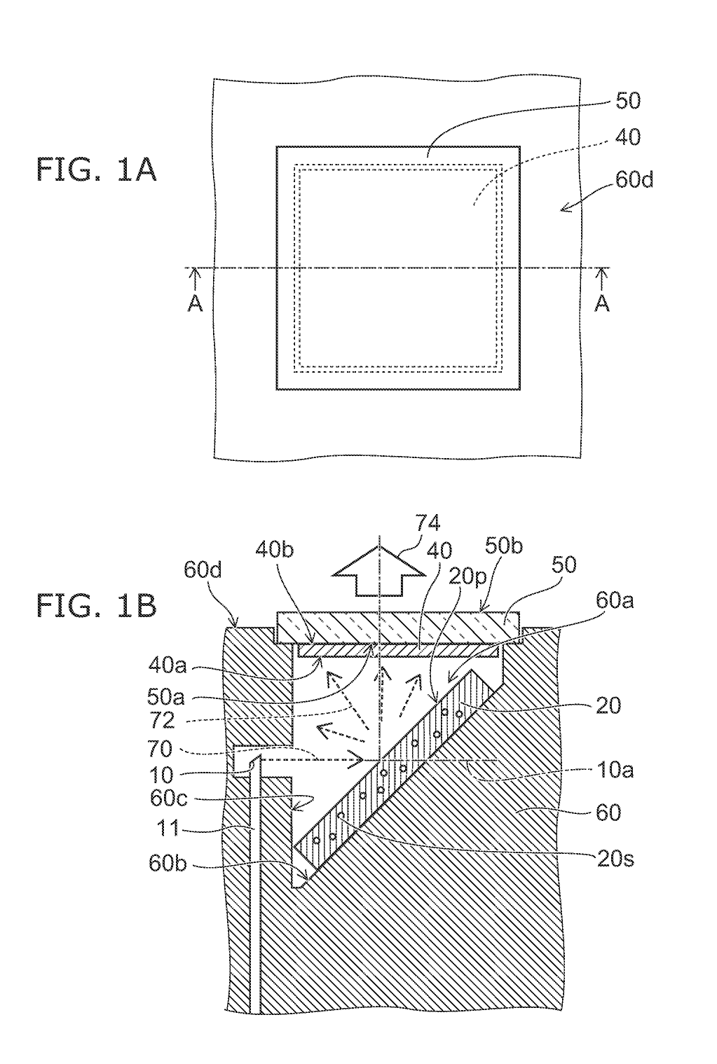

FIG. 1A is a schematic plan view of a solid state lighting device according to a first embodiment. FIG. 1B is a schematic sectional view taken along line A-A in FIG. 1A.

The solid state lighting device includes an irradiating section 10, a scattering section 20, and a wavelength conversion section 40. The irradiating section 10 includes a light source such as a semiconductor laser and emits laser light 70.

The wavelength of the laser light 70 can be, for example, a wavelength of 380 to 490 nm. The irradiating section 10 may further include an optical waveguide body (an optical fiber, etc.) 11 and emit a laser light emitted from the light source after transmitting the laser light.

The scattering section 20 contains a light scattering material 20s that reflects the laser light 70 made incident thereon and emits the laser light 70 as scattered light. The scattering section 20 includes particulates (particle diameter: 1 to 20 μm, etc.) of Al₂O₃, Ca₂P₂O₇, BaSO₄, or the like. The scattering section 20 may be a member in which the particulates are distributed on a ceramic plate.

The wavelength conversion section 40 absorbs scattered light 72 made incident thereon and emits wavelength-converted light having a wavelength longer than the wavelength of the laser light 70. The wavelength conversion section 40 can be phosphor particles formed of YAG (Yttrium-Aluminum-Garnet) or the like. For example, the phosphor particles absorb the scattered light 72 having a wavelength of 380 to 490 nm and emit wavelength-converted lights of yellow, green, red, and the like.

The scattered light 72 transmitted through the wavelength conversion section 40 while being reflected and scattered without being absorbed by the wavelength conversion section 40 and the wavelength-converted light are emitted from the wavelength conversion section 40. Then, mixed light 74 is generated from the scattered light 72 and the wavelength-converted light. When the wavelength of the scattered light 72 is 380 to 490 nm and the wavelength-converted light is yellow light, the mixed light 74 can be white light or the like.

The wavelength conversion section 40 absorbs the scattered light 72 and emits wavelength-converted light having an emission spectrum including a wavelength larger than the wavelength of excitation light G1. As the wavelength conversion section 40, a single phosphor selected out of a nitride phosphor such as (Ca, Sr)₂Si₅N₈:Eu or (Ca, Sr)AlSiN₃:Eu, an oxynitride phosphor such as Cax(Si, Al)₁₂(O, N)₁₆:Eu, (Si, Al)₆(O, N)₈:Eu, BaSi₂O₂N₂:Eu, or BaSi₂O₂N₂:Eu, an oxide phosphor such as Lu₃Al₅O₁₂:Ce, (Y, Gd)₃(Al, Ga)₅O₁₂:Ce, (Sr, Ba)₂SiO₄:Eu, Ca₃Sc₂Si₃O₁₂:Ce, or Sr₄Al₁₄O₂₅:Eu, and a sulfide phosphor such as (Ca, Sr)S:Eu, CaGa₂S₄:Eu, ZnS:Cu, Al or a phosphor obtained by mixing at least one or more kinds of the phosphors can be used.

In the first embodiment, an optical axis 10a of the laser light 70 crosses a principal plane 20p of the scattering section 20. In an example shown in FIG. 1B, the optical axis 10a of the laser light 70 and the principal plane 20p of the scattering section 20 obliquely cross each other. However, the optical axis 10a and the principal plane 20p may cross at a right angle. The laser light 70 made incident on the scattering section 20 from the principal plane 20p is reflected and scattered by the light scattering material 20s dispersed in the scattering section 20 and is emitted. Therefore, even if damage to the scattering section 20 or the wavelength conversion section 40 occurs, it is possible to suppress the laser light 70 from directly irradiating a lighting target. Therefore, it is possible to secure safety for human eyes and the like.

The solid state lighting device can further include a base section 60. A recess 60a receding from an upper surface 60d of the base section 60 is provided in the base section 60. The recess 60a has inner walls 60b and 60c. The scattering section 20 is provided on the inner wall 60b of the recess 60a. The irradiating section 10 is provided in a region opposed to the scattering section 20 on the inner wall 60c of the recess 60a.

In FIG. 1A, the wavelength conversion section 40 is substantially square. The scattering section 20 is provided on the inner wall 60b of the recess 60a and is rectangular.

When the power of the laser light 70 increases, an amount of heat in the wavelength conversion section 40 and the scattering section 20 increase. If the base section 60 is made of metal such as Al, Cu, Ti, Si, Ag, Au, Ni, Mo, W, Fe, or Nb, thermal radiation is improved. Therefore, it is possible to improve light emission efficiency and reliability. When the laser light 70 is low power, the base section 60 does not have to be the metal and can be ceramic, heat-conductive resin, or the like.

The solid state lighting device can further include a first holding plate 50. The first holding plate 50 has a first surface 50a and a second surface 50b on a side opposite to the first surface 50a.

The wavelength conversion section 40 can be a coating layer applied and hardened on the first surface 50a of the first holding plate 50. The second surface 50b of the first holding plate 50 is a light emission surface. The first holding plate 50 can be glass, transparent ceramic, or the like.

The first holding plate 50 is provided to form the recess 60a of the base section 60 as a closed space. When the first surface 50a of the first holding plate 50 and the upper surface 60d of the base section 60 are bonded, it is possible to absorb the laser light 70 and radiate heat generated in the wavelength conversion section 40 to the base section 60. Therefore, it is possible to suppress deterioration in conversion efficiency of the wavelength conversion section 40 due to a temperature rise. A cutout section may be provided on the upper surface 60d of the base section 60 and the first holding plate 50 may be interposed in the cutout section and bonded.

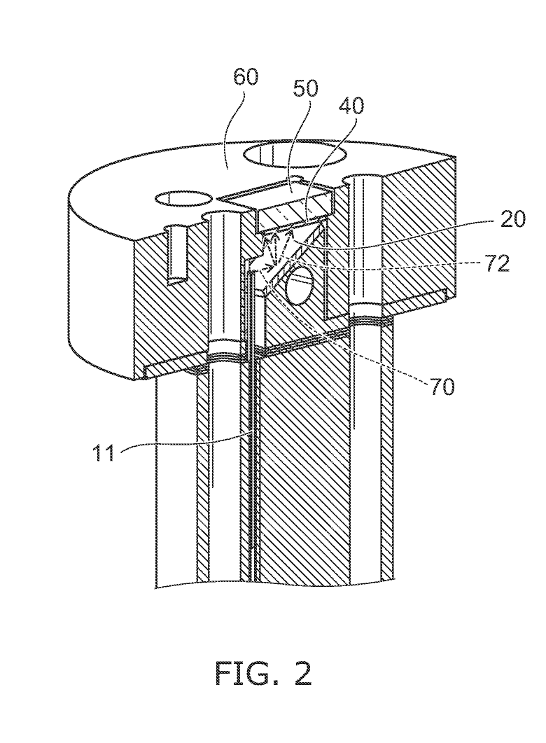

FIG. 2 is a schematic sectional view of the solid state lighting device according to the first embodiment take along line A-A in FIG. 1A.

When the light source is a semiconductor laser, one end face of the optical waveguide body 11 can be an oblique polished surface. The laser light 70 bent on the end face irradiates the scattering section 20.

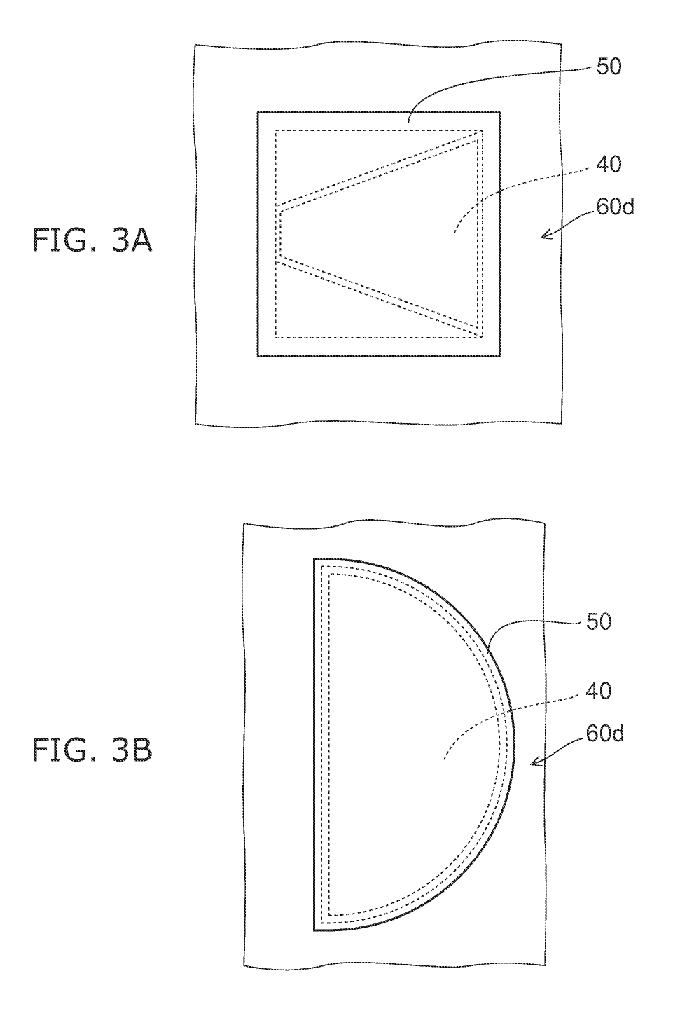

FIG. 3A is a schematic plan view of a first modification of the first embodiment. FIG. 3B is a schematic sectional view of a second modification of the first embodiment.

The scattering section 20 is trapezoidal in FIG. 3A. In FIG. 3B, a recess formed by hollowing out the base plate 60 in a semi-conical shape is provided. The scattering section 20 is provided on the inner wall of the recess. When viewed from above, the scattering section 20 may be a part of a polygon or an ellipse.

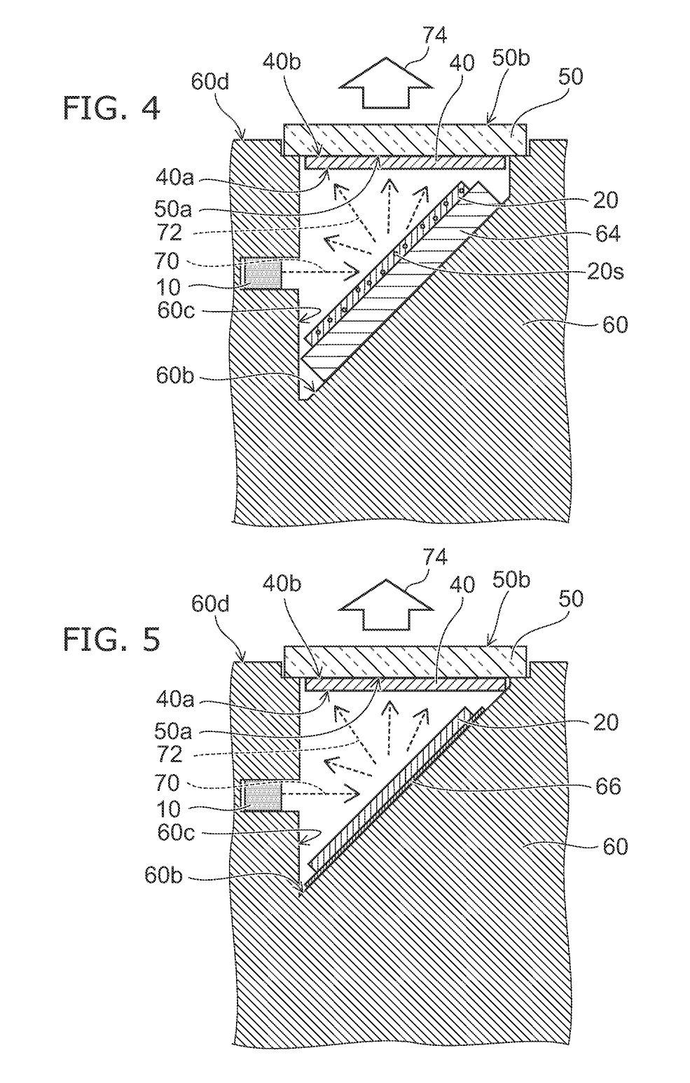

FIG. 4 is a schematic sectional view of a solid state lighting device according to a second embodiment.

The solid state lighting device can further include a second holding plate 64 provided on the inner wall 60b of the recess 60a. The second holding plate 64 is, for example, a glass plate, a transparent resin plate, or a ceramic plate. Particulates of Al₂O₃, Ca₂P₂O₇, BaSO₄, or the like can be applied and hardened on the surface of the second holding plate 64. A scattering section can be formed after the second holding plate 64 is bonded to the base section 60. The ceramic plate may be white (reflective) ceramic.

FIG. 5 is a schematic sectional view of a solid state lighting device according to a third embodiment.

The solid state lighting device can further include a reflecting section 66 in the recess 60a. The reflecting section 66 can be provided between the inner wall 60b of the recess 60a of the base section 60 and the scattering section 20. The reflecting section 66 can be made of metal having high light-reflectance at a wavelength of 490 nm such as Ag or Al.

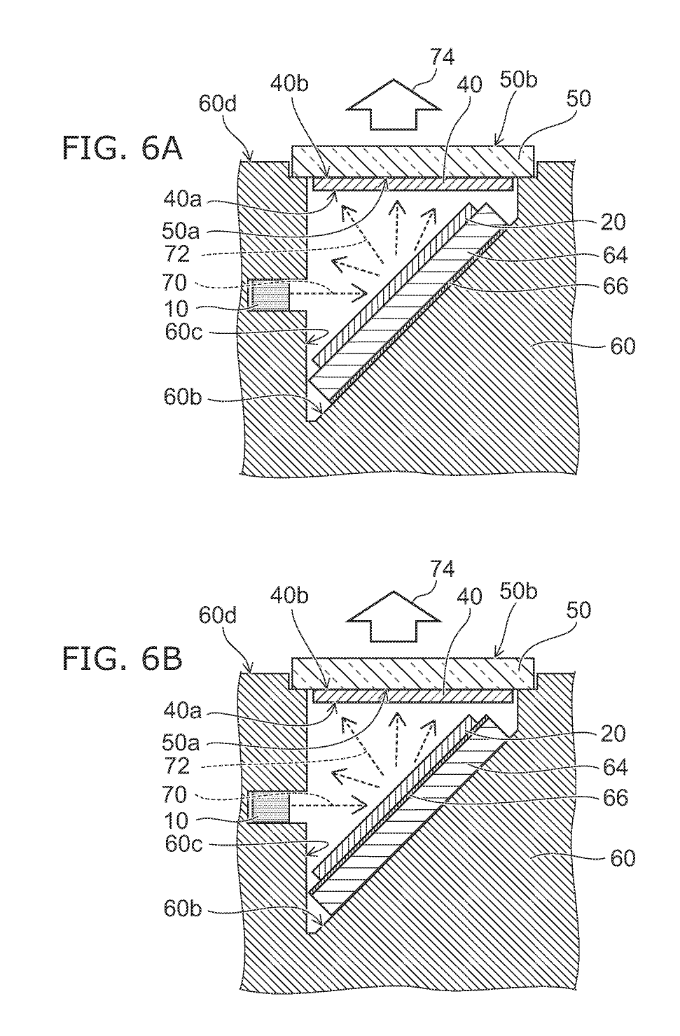

FIG. 6A is a schematic sectional view of a first modification of the third embodiment. FIG. 6B is a schematic sectional view of a second modification of the third embodiment.

In FIG. 6A, the reflecting section 66 is provided between the inner wall 60b of the recess 60a and the second holding plate 64.

In FIG. 6B, the reflecting section 66 is provided between the second holding plate 64 and the scattering section 20. The light-reflectance of Ag or Al does not fall and can be kept high even at a wavelength equal to or smaller than 490 nm. Therefore, a larger amount of scattered light can be reflected to the wavelength conversion section 40. Therefore, it is possible to improve light extracting efficiency.

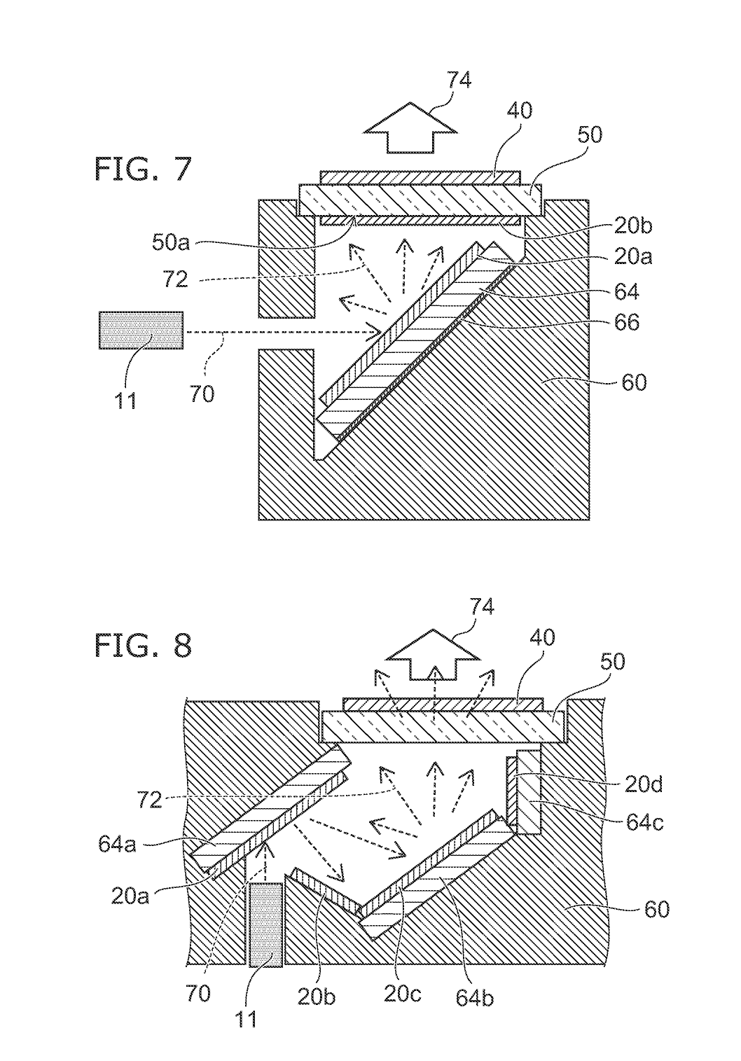

FIG. 7 is a schematic sectional view of a solid state lighting device according to a fourth embodiment.

The solid state light emitting device includes a second scattering section 20b on the first surface 50a of the first holding plate 50 and includes a first scattering section 20a on the second holding plate 64. The scattered light 72 reflected and scattered by the first scattering section 20a is further scattered by the second scattering section 20b and excites the wavelength conversion section 40 provided on the second surface 50b of the first holding plate 50.

Therefore, it is possible to further improve wavelength conversion efficiency. As shown in the figure, the irradiating section 10 may irradiate the laser light 70 emitted from the semiconductor laser on the first scattering section 20a via the optical waveguide body 11.

FIG. 8 is a schematic sectional view of a solid state lighting device according to a fifth embodiment.

The solid state lighting device includes a recess having a substantially pentagonal shape in section. The laser light 70 emitted from the optical waveguide body 11 irradiates the first scattering section 20a. The laser light 70 made incident on the first scattering section 20a is scattered while being reflected in the first scattering section 20a and is emitted.

Scattering and emission are repeated in the same manner in the second scattering section 20b, a third scattering section 20c, and a fourth scattering section 20d. The light multiply scattered in this way is efficiently made incident on the wavelength conversion section 40. Therefore, the light-reflectance of the scattered light 72 is increased and the wavelength conversion efficiency is further improved.

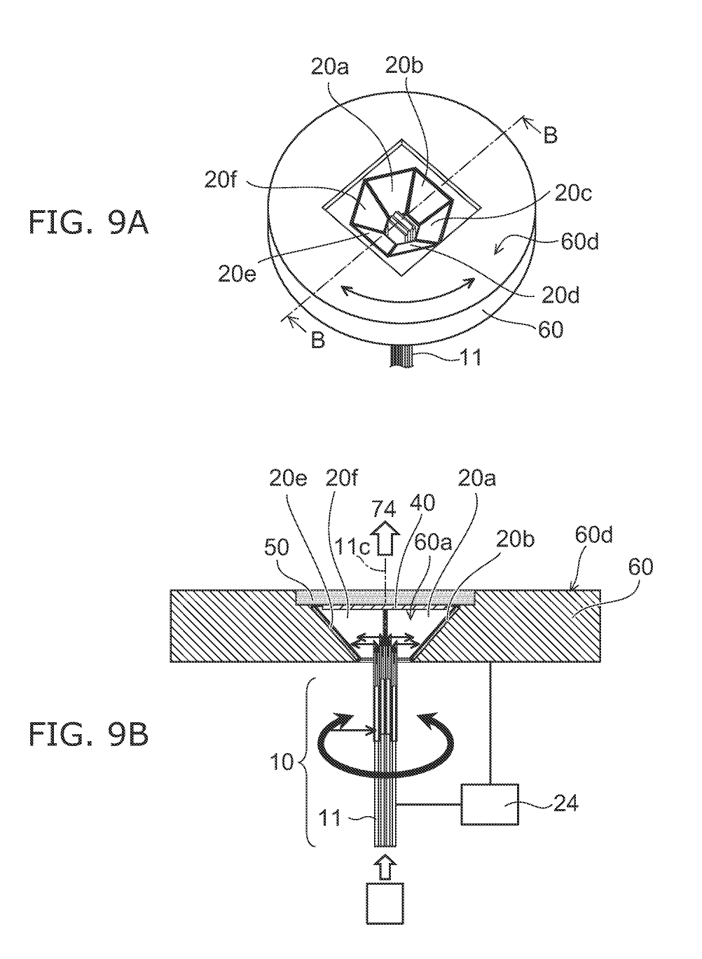

FIG. 9A is a schematic perspective view of a solid state lighting device according to a sixth embodiment. FIG. 9B is a schematic sectional view taken along line B-B in FIG. 9A.

The solid state lighting device includes the irradiating section 10, the scattering section 20, the first holding plate 50, the wavelength conversion section 40, and an irradiation-region moving section 24.

The optical waveguide body (an optical fiber) 11 of the irradiating section 10 emits laser light to the scattering section 20. The scattering section 20 includes, for example, first to sixth regions 20a to 20f in which contents of a light scattering material are different. The irradiation-region moving section 24 moves the position of an irradiation region of the laser light emitted from the irradiating section 10 to the regions 20a to 20f.

For example, the first region 20a and the fourth region 20d on a side opposite to the first region 20a emit scattered lights having substantially the same first light emission intensity. The second region 20b and the fifth region 20e on a side opposite to the second region 20b emit scattered lights having second light emission intensity different from the first light emission intensity. Further, the third region 20c and the sixth region 20f on a side opposite to the third region 20c emit scattered lights having third light emission intensity different from the first and second light emission intensities.

The base section 60 is rotated with an axial direction of the optical waveguide body 11 set as a center axis 11c and an irradiation position of the laser light 70 is switched to the positions of the first region 20a and the fourth region 20d, the positions of the second region 20b and the fourth region 20e, and the positions of the third region 20c and the sixth region 20f to change the light emission intensity of the scattered light. The intensity of wavelength-converted light also changes according to the change of the light emission intensity of the scattered light. The chromaticity of the mixed light 74 can be changed. For example, the chromaticity of mixed light of scattered light of bluish purple to blue and yellow light, which is the wavelength-converted light, can be controlled.

In the solid state lighting devices according to the first to sixth embodiments, it is easy to improve light extraction efficiency and safety. Therefore, the solid state lighting devices can be widely used for general lighting, a spotlight, vehicle-mounted lighting, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A solid state lighting device comprising:
an irradiating section configured to emit laser light;
a scattering section having a principal plane provided to cross an optical axis of the laser light and including a light scattering material that reflects the laser light made incident thereon and emits the laser light as scattered light; and
a wavelength conversion section configured to absorb the scattered light made incident through a first surface and emit wavelength-converted light having a wavelength longer than a wavelength of the laser light from a second surface on a side opposite to the first surface, the scattered light passing through the wavelength conversion section while being scattered and being emitted from the second surface.

2. The device according to claim 1, further comprising a base section having an upper surface and provided with a recess receding from the upper surface,
the scattering section being provided on an inner wall of the recess, and
the irradiating section emitting the laser light to the scattering section.

3. The device according to claim 2, further comprising a first holding plate having a first surface bonded to the upper surface of the base section and a second surface on a side opposite to the first surface,
the wavelength conversion section being a coating layer provided on the first surface of the first holding plate, and
the second surface of the first holding plate being a light emission surface.

4. The device according to claim 2, further comprising a reflecting section provided between the inner wall of the base section and the scattering section.

5. The device according to claim 3, further comprising a reflecting section provided between the inner wall of the base section and the scattering section.

6. The device according to claim 2, further comprising a second holding plate provided on the inner wall of the recess,
the scattering section being provided on a surface of the second holding plate.

7. The device according to claim 6, wherein the second holding plate includes white ceramic.

8. The device according to claim 6, further comprising a reflecting section provided between the inner wall of the recess of the base section and the second holding plate or between the second holding plate and the scattering section.

9. The device according to claim 8, wherein the second holding plate includes white ceramic.

10. The device according to claim 3, further comprising a second holding plate provided on the inner wall of the recess,
the scattering section being provided on a surface of the second holding plate.

11. The device according to claim 10, wherein the second holding plate includes white ceramic.

12. The device according to claim 8, further comprising a reflecting section provided between the inner wall of the recess of the base section and the second holding plate or between the second holding plate and the scattering section.

13. The device according to claim 12, wherein the second holding plate includes white ceramic.

14. A solid state lighting device comprising:
an irradiating section configured to emit laser light having a wavelength equal to or longer than 380 nm and equal to or shorter than 490 nm;
a scattering section having a principal plane provided to cross an optical axis of the laser light and including a light scattering material that reflects the laser light made incident thereon and emits the laser light as scattered light; and
a wavelength conversion section configured to absorb the scattered light made incident through a first surface and emit wavelength-converted light having a wavelength longer than a wavelength of the laser light from a second surface on a side opposite to the first surface, the wavelength conversion section including any one of a nitride phosphor, an oxynitride phosphor, an oxide phosphor, and a sulfide phosphor, and
the scattered light passing through the wavelength conversion section while being scattered and is emitted from the second surface.

15. The device according to claim 14, wherein mixed light of the scattered light and the wavelength-converted light includes white light.

16. The device according to claim 14, further comprising a base section having an upper surface, provided with a recess receding from the upper surface, and including any one of metal, ceramic, and heat-conductive resin, the scattering section being provided on an inner wall of the recess, and
the irradiating section emitting the laser light to the scattering section.

17. The device according to claim 14, further comprising a reflecting section provided between the inner wall of the base section and the scattering section and including Ag or Al.
